(19) United States
(12) Patent Application Publication
(10) Pub. No.: US 2009/0038220 A1
(43) Pub. Date: Feb. 12, 2009

(54) Planter platform

(76) Inventor: Lawson Guthrie, (US)

Correspondence Address: Lawson Guthrie, 14742 NW Vance Drive, Portland, OR, 97229, US

(21) Appl. No.: 12/286,592

(22) Filed: Oct. 1, 2008

Related U.S. Application Data
(63) Continuation-in-part of application No. 11/975,624, filed on Oct. 22, 2007.
(60) Provisional application No. 60/874,906, filed on Dec. 15, 2006.

(51) Int. Cl. A01G 9/02

(52) U.S. Cl. 47/85; 47/86

(57) ABSTRACT

A planter insert extends the usefulness of a planter by creating a plurality of containers that fit within a planter. The containers may be supported by a planter platform suitably adapted to fit within the inside of the planter. The planter platform may suitably include an expansion member adapted to stabilize the planter platform. A suitably planter platform may also be modular enabling the planter platform to be disassembled and suitably stacked during storage or shipping.

This application is a Continuation-In-Part of application Ser. No. 11/975,624 filed Oct. 22, 2007 which in turn claims priority from U.S. Provisional Application 60/874,906 filed Dec. 15, 2006.

### BACKGROUND OF THE INVENTION

1. Field of the Invention.

This invention relates to indoor and outdoor planters commonly used in or around households and commercial buildings. More particularly, it relates to an extensible platform positioned inside a planter to preferably support other items such as soil, a container, or an arrangement of containers.

2. Description of Related Art

Planter platforms 110, which are typically placed inside a planter 70 to support soil or smaller containers inside the planter 70, face the challenge of being extensible to fit within a range of standard planters 70. Additionally, planter platforms 110 face the challenge of being modular, enabling them to be taken apart for shipping and storage purposes.

Kristine Ann Maniscalco and John Jeffrey Maniscalco U.S. Pat. No. 7,278,238 B2 defines a support platform for use in combination with an “oversized” planter. The support platform creates a false bottom to reduce the over-all depth of soil in the planter, thereby reducing the over-all container mass.

Steven W. Pavelka U.S. Pat. No. 6,125,579 defines a drainage disk and reservoir system for a planter, whereby the soil is held above the reservoir by the disk.

James J. Diorio and Robert P. Hubbell U.S. Pat. No. 5,722,201 defines a system for supporting and irrigating a container within a planter.

Randy K. Hulsebus U.S. Pat. No. D382,512 illustrates an ornamental design for a planter with a soil support system.

Arthur R. Carlson U.S. Pat. Nos. D352,479 and D352,480 separately illustrate ornamental designs for a planter with a “plate” or support structure for elevating the soil in a planter.

Jack D. Hanson U.S. Pat. No. 4,014,506 defines a support collar assembly for suspending standard flower pot within a larger-diameter container. The collar is held by the container by hangers attached to the container's rim. Similarly, Milagros Rush and Gary Rush U.S. Pat. No. 6,6412,740 defines an adjustable pot support device.

Mortimer M. Schackett and Jay L. Schackett U.S. Pat. No. 2,463,719 define an interchangeable plant receptacle.

Grzegorz Trabka U.S. Pat. No. 6,901,700 B2 utilizes a support structure within a planter for removable pots with the remaining area in a fixed configuration with soil and plants.

James A. Peter U.S. Pat. No. 7,296,379 defines a support rack system with hooks that come in contact with the upper rim of a planter and suspends a container.

Leon E. Laux U.S. Pat. No. 4,048,754 defines a custom planter box with supports for removable pots.

Carlos Gonzalez, Sr. U.S. Pat. No. D502,794 S defines an equally subdivided planter cart as a support structure for removable pots.

Ronald M. Caird U.S. Pat. No. 5,094,060 illustrates a basket and support structure to hold removable pots.

Abraham I. Tenzer and Jes S. Baru Des. 268,337 defines the ornamental design for a collection of custom planters with an elevated center pot.

Curtis J. Bouler U.S. Pat. No. 6,269,589 B1 utilizes containers as planters for trees, poles and other vertical surfaces.

### SUMMARY

The present planter platform 110 extends the usefulness of a planter 70 by creating a platform to support soil, another container, an independent vessel 30, a plurality of containers, or container inserts 10 inside a planter 70. The planter 70 acts as the outer shell and may be decorative, whereas the planter platform 110 may support another container, an independent vessel 30, a plurality of containers, or a plurality of container inserts 10 that may be concealed or obscured from general view. The planter platform 110 may provide improved portability of the planter 70 by reducing the aggregate amount of soil and supporting a modular configuration of the container inserts 10. According to a suitable embodiment, the planter platform 110 itself may be of a modular design, extensible and independently removable. A suitable embodiment of the planter platform 110 may include a platform portion 140 and a stabilization portion 130, which suitably includes an expansion member 120. A suitable embodiment of the planter platform 110 may also include a cavity 112. A more suitable embodiment of the planter platform 110 may include a container riser 150 to elevate a container's visibility within the planter 70, a drainage system 160 to drain any excess water, a self-watering system 180, and a container stabilization system 170 to help stabilize the container inserts 10 supported by the planter platform 110.

According to an exemplary embodiment, the planter platform 110 and plurality of container inserts 10 may be designed as part of a modular planting system. However, according to another suitable embodiment, the planter platform 110 may be designed to support soil, a commercially available container, a plurality of commercially available planting containers, a plurality of container inserts 10, or any combination of soil, commercially available planting containers and container inserts 10. Similarly, according to another suitable embodiment the container inserts 10 may be supported by the planter platform 110, or according to other suitable embodiments the container inserts 10 may use nominal to no support structures or platforms and may use a friction fit and/or a taper lock for support.

### BRIEF DESCRIPTION OF THE DRAWINGS

The following descriptions and drawings are used to describe components of a suitable embodiment of a planter platform 110 and a suitable embodiment of container inserts 10 that the planter platform 110 may be suitably adapted to support within a planter 70.

10—A suitable embodiment of a plurality of container inserts
12—A suitable embodiment of a plurality of container inserts 10 with an Independent Vessel 30

20—A suitable embodiment of one of the plurality of container inserts 10
21—A container insert 20 in a single-row configuration or in the row closest to the inside wall surface 74
22—First Side Portion of a suitable embodiment of a container insert 20
23—A container insert 20 in a multi-row configuration beyond the single-row configuration and single-row container insert 21
24—Second Side Portion of a suitable embodiment of a container insert 20
26—Third Side Portion of a suitable embodiment of a container insert 20. This may also refer to the Front of the container insert 20.
27—Container stabilizer receptacle
28—Bottom Side Portion of a suitable embodiment of a container insert 20
29—Back Side Portion of a suitable embodiment of a container insert 20

30—Independent Vessel
32—Circular Independent Vessel cavity
33—Circular Independent Vessel
34—Square Independent Vessel cavity
35—Square Independent Vessel
36—Open-bottom container

40—Removably Coupled
42—Lip Lock
44—Standing Male Coupler
46—Standing Female Coupler

48—Contoured edge

50—Drip Irrigation supports
52—Notches to support drip system tubing
54—A larger radius to create a gap for drip system tubing when paired with another of the plurality of container inserts 20.

60—Container drainage holes

70—Planter
72—Inside planter surface
74—Inside wall surface
76—Inside bottom surface

110—Planter platform
112—Cavity

120—Expansion member
122—Foot pad
123—Water liner hook
124—Ankle drain
126—Expansion member dowel
127—Expansion member lever
128—Support Brace
129—Stabilizer Arm

130—Stabilization portion
132—Expansion member grips
134—Stabilization tongue
136—Stabilization hook
138—Expansion member regulator

140—Platform Portion
142—Platform water outlet
143—Platform Groove
144—Platform rib
145—Platform Eye
146—Container hook
148—Riser stabilizer

150—Container riser
152—First side riser portion
154—Second side riser portion
156—First side riser connector portion
158—Second side riser connector portion

160—Drainage system

170—Container Stabilization system

180—Self-watering system
182—Watering reservoir
184—Capillary Wick
186—Plastic Liner

FIG. 1 shows the Front or Third Side Portion 26 view of a suitable embodiment of a container insert 20.

FIG. 2 shows a Back Side Portion 29 view of a suitable embodiment of a container insert 20

FIG. 3 shows a First Side Portion 22 view of a suitable embodiment of a container insert 20 and a Lip Lock 42

FIG. 4 shows a Second Side Portion 24 view of a suitable embodiment of a container insert 20.

FIG. 5 shows the top view of a suitable embodiment of two container inserts 20 coupled outside the planter 70 in a Front-to-Back Contoured Fit.

FIG. 6 shows a suitable embodiment of a coupling system using a Standing Male Coupler 44 and a Standing Female Coupler 46.

FIG. 7 shows a suitable embodiment of a plurality of container inserts 12 with a circular Independent Vessel cavity 32

FIG. 8 completes FIG. 7 and the planter insert configuration by adding the circular Independent Vessel 33

FIG. 9 shows a suitable circular planter insert configuration with a plurality of container inserts 10

FIG. 10 shows a suitable circular, multi-row planter insert configuration with two complimentary designs of container inserts 21 and 23.

FIG. 11 shows a suitable square planter insert configuration with a plurality of container inserts 10

FIG. 12 shows a suitable rectangular planter insert configuration with a plurality of container inserts 10

FIG. 13 shows a suitable circular configuration with a plurality of container inserts 12 and an Independent Vessel cavity 32

FIG. 14 shows a suitable circular configuration with a plurality of container inserts 12 and a square Independent Vessel cavity 34

FIG. 15 shows a suitable square configuration with a plurality of container inserts 12 and a circular Independent Vessel cavity 32

FIG. 16 shows a suitable circular and multi-type planter insert configuration with a plurality of container inserts 10

FIG. 17 shows the top view of a suitable embodiment of a planter platform 110 inside a circular planter 70

FIG. 18 shows the top view of a suitable embodiment of an assembled modular planter platform 110

FIG. 19 shows the cross sectional view of a suitable embodiment of a planter platform 110 with container inserts 20 inside a planter 70

FIG. 20 shows a suitable configuration of a plurality of container inserts 12, including an elevated independent vessel 30, on a planter platform 110.

FIG. 21 shows the top view of a suitable embodiment of an exploded modular planter platform 110

FIG. 22 shows the bottom view of a suitable embodiment for an exploded modular planter platform 110

FIG. 23 shows the top view of a suitable embodiment of an expansion member 120

FIG. 24 shows the bottom view of a suitable embodiment of an expansion member 120

FIG. 25 shows the top view of a suitable embodiment of a stabilization portion 130

FIG. 26 shows the bottom view of a suitable embodiment of a stabilization portion 130

FIG. 27 shows the top view of a suitable embodiment of a platform portion 140

FIG. 28 shows the bottom view of a suitable embodiment of a platform portion 140

FIG. 29 shows a suitable embodiment of an expansion member 120 insertion into a stabilization portion 130

FIG. 30 shows a suitable embodiment of an interlocking platform portion 140 and stabilization portion 130

FIG. 31 shows a suitable embodiment of a container riser 150 on a planter platform 110

FIG. 32 shows a suitable embodiment of a modular container riser 150

FIG. 33 shows a cross sectional view of a planter 70 with a planter platform 110, where a plant in an open-bottom container 36 may utilize the soil below the planter platform 110

FIG. 34 shows the bottom view of a suitable embodiment of a container insert 20 with stabilizer receptacles 27 that may fit with a container hook 146.

FIG. 35 shows a suitable embodiment of a cavity 112 on a planter platform 110

FIG. 36 shows a suitable embodiment of a self-watering system 180

FIG. 37 shows another suitable embodiment of a stabilization portion 130

FIG. 38 shows another suitable embodiment of a locking mechanism of expansion members 120 in a stabilization portion 130

FIG. 39 shows another suitable embodiment of a stabilization portion 130 in a planter 70

FIG. 40 shows a suitable embodiment of a water liner hook 123

FIG. 41 shows another suitable embodiment of a platform portion 140 and an assembled planter platform 110

FIG. 42 shows another suitable embodiment of a planter platform 110 in a planter 70

FIG. 43 shows another suitable embodiment of a planter platform 110 with two container inserts 20

FIG. 44 shows the top view of another suitable embodiment of a modular planter platform 110

FIG. 45 shows the top view of another suitable embodiment of an expansion member 120

FIG. 46 shows the bottom view of another suitable embodiment of an expansion member 120

FIG. 47 shows the top view of another suitable embodiment of a stabilizer portion 130

FIG. 48 shows the bottom view of another suitable embodiment of a stabilizer portion 130

FIG. 49 shows the top view of another suitable embodiment of a platform portion 140

FIG. 50 shows the top view of another suitable embodiment of a platform portion 140

### DESCRIPTION OF A SUITABLE EMBODIMENT

This invention is described with respect to the preferred physical embodiments constructed in accordance herewith. It will be apparent to those skilled in the art that various modifications and improvements may be made without departing from the scope and spirit of the invention. Accordingly, the invention is not limited by the specific embodiments illustrated and described, but only by the scope of the appended claims.

1. General Description

The present invention relates to a planter platform 110 for inserting into a planter 70 to hold soil, a single commercially available container, an independent vessel 30, a plurality of commercially available containers, container inserts 10 or a combination thereof. The planter platform 110 may be suitably configured to provide a support structure within mid- to large-sized planters 70, more suitably 16″ planters 70 and above. The planter platform 110 is elevated inside a planter 70, thereby allowing increased visibility of the contents of the containers or container inserts 10. Preferably, the planter platform 110 may be concealed or obscured from general view and is not readily visible when fully populated with soil, containers, or container inserts 10.

The planter platform 110 may provide improved portability of the planter 70 by reducing the aggregate amount of soil and supporting a modular configuration of containers or container inserts 10. The planter platform 110 may be extensible to support a range of planter 70 sizes and may be modular so that it can be broken down for shipping or storage. The planter platform 110 may also be independently removable, provide drainage mechanisms and employ mechanisms to strengthen the planter platform 110.

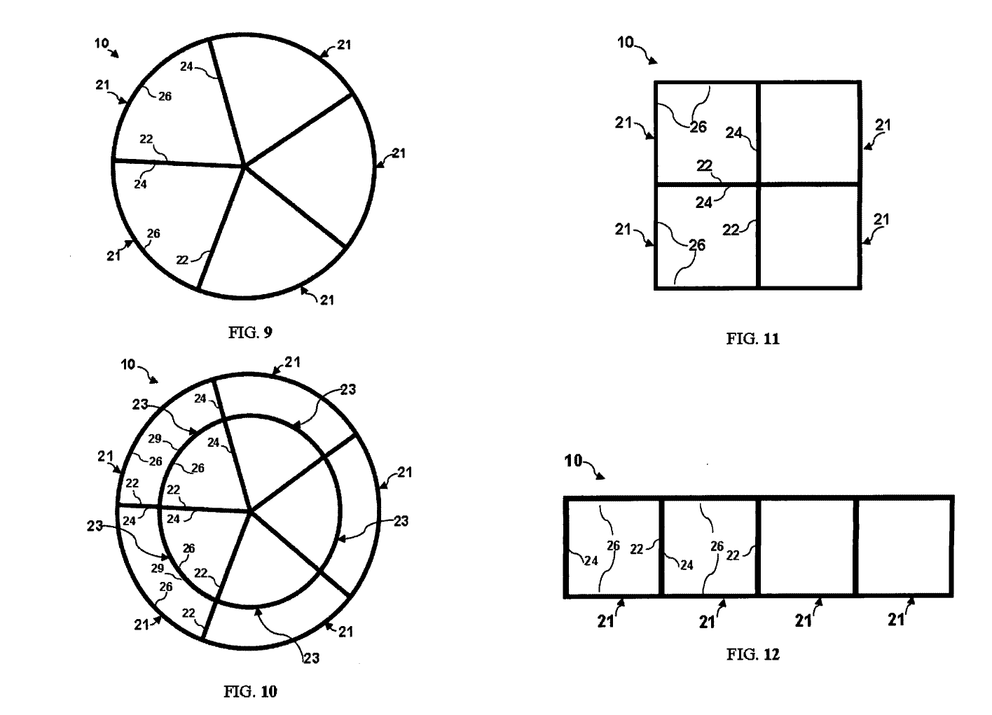

According to a suitable embodiment, the planter platform 110 may be configured to support a plurality of container inserts 10 for inserting into a planter 70. The plurality of container inserts 10 may conform to the general inside shape of the planter 70 in a variety of planter insert configurations FIG. 9-16 and provide improved redesign and portability while minimizing wasted space.

The general purpose of a container insert 20 may be the same as that of a typical flower pot, which is to hold a plant(s) and soil. Optionally, it may hold artificial plants or any other object that may be placed in a planter 70. The container insert 20 may be minimally visible once inside the planter 70. The container insert 20 may be portable and reusable. The plurality of container inserts 10 within a target planter insert configuration may be of uniform size and therefore swappable and stackable.

2. Suitable Planter Insert Configurations

The plurality of containers 10 may be designed to support a target planter insert configuration, design or pattern within a planter 70 or collection of planters 70. The planter insert configuration may be populated exclusively with a plurality of container inserts 10. The planter insert configuration may also be designed with an Independent Vessel(s) 30 or some other object, most suitably a center Independent Vessel 30.

A full or partial planter insert configuration for a plurality of container inserts 10 may optionally be molded together. This may also include subdividing the inside of a container insert 20 into multiple compartments.

Planter: The term planter 70 is well understood as a container for plants, typically decorative in nature and commonly used in or around households and commercial buildings. The planter 70 itself may be circular, oval, square, rectangular or of some other shape. The planter 70 may be permanent/fixed, temporary/movable, hanging, or of some other design.

A suitable planter insert configuration for circular planters 70 may include a plurality of pie shaped container inserts 10 as shown in FIG. 9.

A suitable planter insert configuration for square planters 70 is illustrated by a plurality of container inserts 10 in FIG. 11.

A suitable planter insert configuration for rectangular planters 70 is illustrated by a plurality of container inserts 10 in FIG. 12.

Generally Conforms to the Inside Shape of a Planter 70: An exemplary planter insert configuration of a plurality of container inserts 10 may generally conform to the inside shape of a planter 70, whereby the inside measurements of the planter 70 are substantially the same as the outside measurements of the plurality of container inserts 10.

Substantially Fills the Top Surface Area of a Planter 70: An exemplary completed planter insert configuration may substantially fill the top surface area of the planter 70, where the measurements of the top inside wall surface 74 are substantially the same as the top outside measurements of the plurality of container inserts 10. The plurality of container inserts 10 may visibly fill the area of the planter 70 open to the elements and may minimize or altogether eliminate any wasted space from support structures or gaps.

As illustrated in FIG. 8, the plurality of container inserts 12 with Independent Vessel 33 substantially fill the top surface area of the planter 70. Further exemplary planter insert configurations are shown in FIG. 9-16 when Independent Vessel cavities 32 and 34, or cavity 112, are filled with an appropriate Independent Vessel 30.

Container inserts 20 may include a lip extension, suitably ¼ to ¾ inch, at the top edge of the Third Side Portion 26 to fill minor gaps between the plurality of container inserts 10 and the inside wall surface 74. The Lip Extension may be flat, curved or of any other shape to complement the inside rim of the planter 70. If the plurality of container inserts 10 is tight-fitting, the lip extension may rest on the top rim of the planter 70. The lip extension may further accommodate minor deviations from a broad range of planter 70 manufacturers.

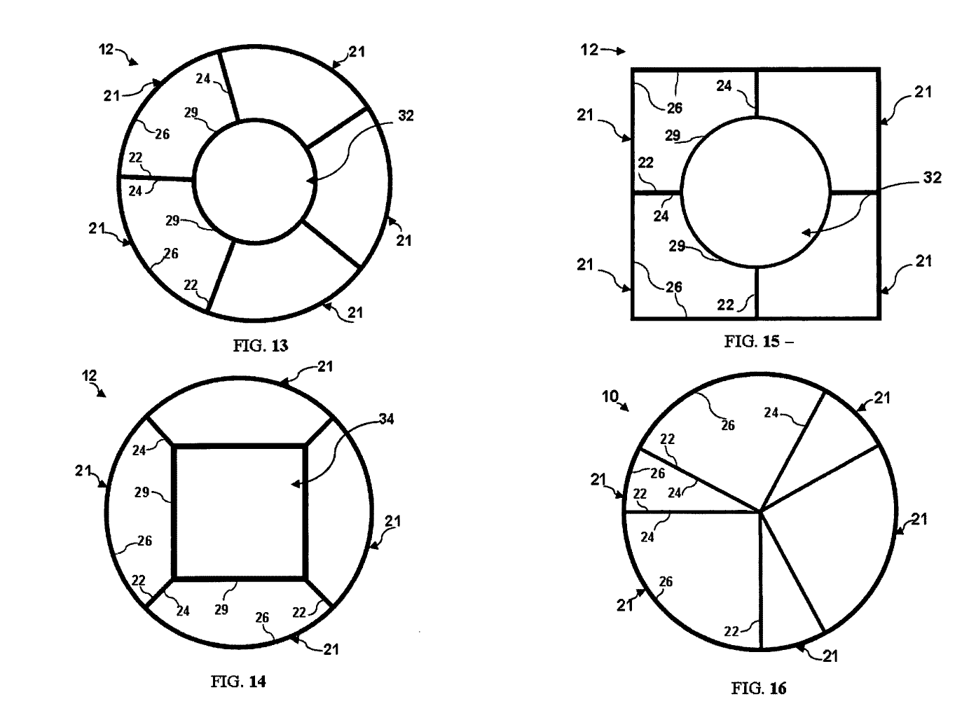

Uniform Design: The plurality of container inserts 10 within a planter insert configuration may be of different shapes and sizes. Most suitably, container inserts 20 may be of uniform dimension by subdividing the top surface area of the planter 70 into equal segments FIG. 9, 11-12. The uniform design may also apply to multi-row configurations FIG. 10 and planter insert configurations with an Independent Vessel(s) 30 FIG. 13-15.

Alternate and also suitable planter insert configurations may include a few uniform designs. A suitable multi-type configuration with multiple uniform designs is illustrated in FIG. 16.

Minimal Support Structures: A completely populated planter insert configuration may minimize or altogether eliminate support structures to secure the plurality of container inserts 10 within the planter 70.

There may be implementations where nominal support would be advantageous. An example may include partial-depth implementations where nominal support beneath the plurality of container inserts 10 would aid when swapping individual container inserts 20 into or out of the planter 70.

Support Structures: Container inserts 10 may be supported by a support structure. A suitable support structure may include a platform responsive to the planter 70. According to a suitable embodiment, the platform may include a stabilization member responsive to an inside surface 72 of the planter 70 such as an extension member (e.g. expansion member 120) responsive to an inside wall surface 74 of a planter 70, an extension member responsive to an inside bottom surface 76 of a planter 70, or an extension member responsive to the top edge of the planter 70.

Tight-Fitting and Friction Fit: The plurality of container inserts 10 may conform to the general inside shape of the planter 70 and be tight-fitting. Container inserts 20 may be held in place or secured by gravity within the planter 70. For tapered planters 70, tight-fitting may also be referred to as a friction fit or taper lock caused by interference of the two tapered shapes colliding.

The plurality of container inserts 10 may use a locking or coupling system to ensure a tight fit of the planter insert configuration within the planter 70.

Varied Quantity of Container Inserts 20: The number of container inserts 20 may vary depending on the design and size of the planter 70. For example, instead of five container inserts in FIG. 9, other suitable planter insert configurations may include four, six, seven or any other suitable number.

In large planters 70, multi-row configurations may be advantageous. A multi-row configuration with container inserts 21 and 23 is illustrated in FIG. 10. Each row may have its own design and may also use multiple types of container inserts 20 within a row to complete the planter insert configuration.

Independent Vessel: Planter insert configurations may include an Independent Vessel 30 around which a plurality of container inserts 12 is designed. The Independent Vessel 30 may be located anywhere in the planter insert configuration, such as off to a side or towards the back, but most suitably will be in the center. The Independent Vessel 30 may serve the same general purpose as a container insert 20 which is to hold a plant(s) and soil, or any other object that may be placed in a planter 70.

The Independent Vessel 30 may be fixed within the planter 70 or removable and therefore replaceable in the planter insert configuration.

The Independent Vessel 30 may be elevated to allow improved visibility of its contents. A suitable embodiment for elevating the independent vessel 30 or any other container in a planter insert configuration is the container riser 150.

The Independent Vessel 30 may be of any shape, though most suitably will be circular 33 or square 35. Suitable embodiments of a plurality of container inserts 12 with an Independent Vessel cavity 32 and 34, or cavity 112, are shown in FIGS. 13-15. Multi-row FIG. 10 and multi-type FIG. 16 configurations may also include an Independent Vessel 30.

The Independent Vessel 30 may complete a planter insert configuration when placed in an Independent Vessel cavity 32 & 34, or cavity 112, formed by a plurality of container inserts 20.

There may be more than one Independent Vessel 30 in a planter insert configuration.

Visibility: A plurality of container inserts 10 may be concealed or obscured from general view so as not to detract from the aesthetics of the planter 70 and plants.

3. Suitable Container Insert Characteristics

The shape and size of the container insert 20 may be determined by the shape and size of the target planter(s) 70 and the target planter insert configuration.

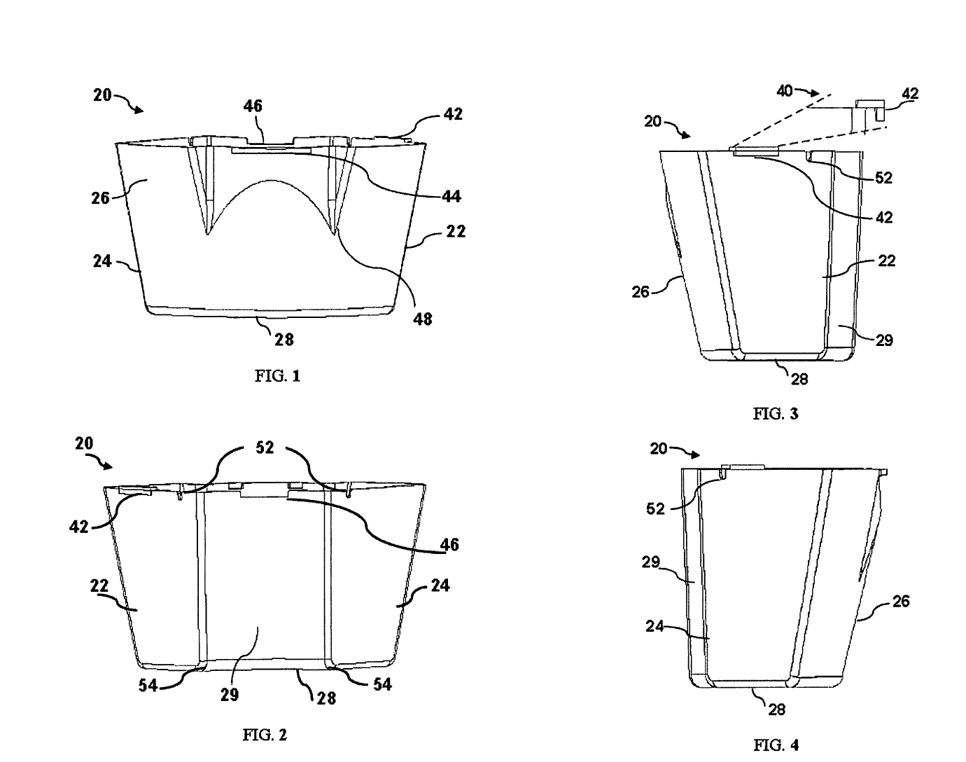

General Shape: The container insert 20 may have any number of sides, but most suitably will have a Bottom Side Portion 28 and at least two side portions: a First Side Portion 22, a Second Side Portion 24 and suitably at least one Third Side Portion 26. A suitable embodiment is illustrated in FIG. 1-4.

The Bottom Side Portion 28 is the bottom of the container when in a vertical position and has contact with the First 22, Second 24 and suitably Third 26 Side Portions. Additional side portions may be used.

The container insert 20 may additionally have a Back Side Portion 29, most suitably with Independent Vessel and multi-row configurations FIG. 2-4, 10, 13-15.

Single-Row Container Insert 21: In a single-row configuration, at least one Side Portion of the container insert 21 may face or have contact with the inside wall surface 74, suitably the Third Side Portion 26 in FIGS. 9, 11-16.

Multi-Row Container Insert 23: In a multi-row configuration, the outer most row of container inserts 21 may follow the same principles as a single-row configuration with respect to its relationship with the planter 70. The inside row(s) of container inserts 23 in a multi-row configuration may not have contact with the inside wall surface 74 but rather with the next row in succession to the outermost row of container inserts 21. Most suitably the Third Side Portion 26 of container insert 23 will face the Back Side Portion 29 of container insert 21 as illustrated in FIG. 10 in a two row configuration.

Stackable: The uniform shape allows the plurality of container inserts 10 to be stackable. Multi-type configurations may also be stackable. This may be valuable so as to minimize production, packaging, shipping and storage costs. The uniform shape also allows each design of a plurality of container inserts 10 to more easily be swapped into and out of planters 70.

Locking System: A container insert 20 may include a locking system to secure or stabilize one of the plurality of container inserts 10 to another of the plurality of container inserts 10. A suitable embodiment of a locking system is the Lip Lock 42 as shown in FIG. 2, 3, 7-8.

The Lip Lock 42 may enable container inserts 20 to remain level within the planter 70, even when support beneath the Bottom Side Portion 28 is uneven.

The Lip Lock may also be used to connect container inserts 21 and 23 in a multi-row configuration.

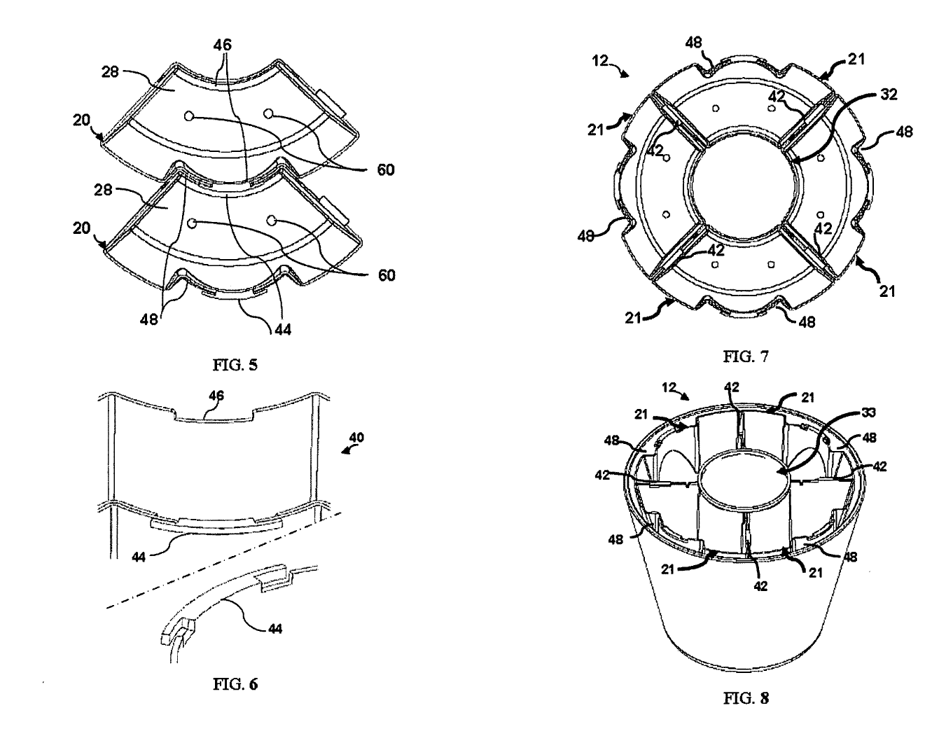

Coupling System: A container insert 20 may use a coupling system to adjoin one of the plurality of container inserts 10 to another of the plurality of container inserts 10. A suitable embodiment of a coupling system is provided in FIG. 5-6 wherein the Standing Male Coupler 44 is joined with a Standing Female Coupler 46 to provide stability for multiple container inserts 20 when freely standing outside of the planter 70.

Front-to-Back Contoured Fit: A container insert may use a Front-to-Back Contoured Fit when set outside the planter 70. This may add greater stability or make better use of available space. A suitable embodiment of a Front-to-Back Contoured Fit is shown in FIG. 5 wherein the Third Side Portion 26 has a contoured edge 48 to allow a tight fit with the Back Side Portion 29 of another container insert 20 outside the planter 70.

Extraction System: Container inserts 20 may include an extraction system to facilitate their removal from the planter 70. This may be necessary when the plurality of container inserts 10 is tight-fitting within a planter 70. A suitable embodiment is shown in FIG. 1, 5, 7-8 where the contoured edge 48 facilitates inserting a finger(s) or other object(s) between the container insert 20 and the inside wall surface 74 of the planter 70.

Varied Depth: Container inserts 20 and planter insert configurations may be designed to a full or partial depth within the planter(s) 70.

Support for Drip System Tubing: Support for drip irrigation tubing may be added to the container insert 20. A suitable embodiment is shown in FIG. 2-4 with the addition of notches 52 to the top of the container insert 20 to hold and conceal the tubing. Independently, notches 52 may also facilitate overflow between container inserts 20 when watered.

Container inserts 20 may be designed to enable drip system tubing to come up from beneath or between a plurality of container inserts 10. A suitable embodiment is shown in FIG. 2 where a larger radius 54 on the comers of paired container inserts 20 produces a gap for the drip system tubing.

Drainage Holes: Container inserts 20 may include container drainage holes 60. A suitable embodiment is shown in FIG. 5.

4. Materials Suitably Used in Container Inserts 20

Container inserts 20 can be made with a variety of materials and methods. In an exemplary embodiment, materials may be of molded plastic material or polymer. More suitably, a container insert 20 may be made from injection molding using ABS like material or Thermo-forming using a variety of composite materials.

5. Suitable Planter Platform 110 Configurations

Planter: The term planter 70 is well understood as a receptacle for plants, typically decorative in nature and commonly used in or around households and commercial buildings. The planter 70 may be circular, oval, square, rectangular or of some other shape. A suitable embodiment of a planter 70 may include an inside planter surface 72, which suitably may include an inside wall surface 74 and an inside bottom surface 76. The planter 70 may be permanent/fixed, temporary/movable, hanging, or of some other design. A suitable planter platform 110 configuration for circular planters 70 is given in FIG. 17-19, 31, 44.

According to a preferable embodiment, a planter platform 110 may be adapted to fit inside a planter 70 that is tapered downward, meaning the measurements at the top/open end of the planter 70 are larger than the measurements at the bottom/base of the planter 70, FIG. 19.

According to other suitable embodiments, planter platform 110 may include a mechanism that increases the force applied against the planter 70. Suitable mechanisms may include a spring, a screw, a hook, a latch, a hook, or a grip responsive to the planter 70. Other suitable mechanisms may include a support leg, a tripod, or other downwardly extending members. Such mechanisms may be suitably adapted for use with planters 70 that do not include a taper.

Suitable Planter platform 110 members: An exemplary planter platform 110 may include a platform portion 140, and a stabilization portion 130.

The platform portion 140 may take various shapes or sizes or more fully extend to conform to the general inside shape and size of a planter 70. Suitably, the platform portion 140 may extend to the inside wall surface 72 in order to support loose items such as soil. The platform portion 140 may directly hold or provide a means for seating objects placed on the planter platform 110 such as a container, container inserts 10 or a container riser 150. Suitably, the platform portion 140 may provide a surface responsive to the items to be seated on or held by a planter platform 110, including a container hook 146, a riser stabilizer 148, and a platform water outlet 142, FIG. 27. The platform portion 140 may provide a continuous surface (either in whole or when assembled), or it may complete a modular configuration with a stabilization portion 130. According to other suitable embodiments, the platform portion 140 may include little more than a series of connecting rods in order to hold items as they pertain to a planter platform 110. Suitably, platform portion 140 may be configured to support a specific item or items, or adaptable so as to support a plurality or combination of different items.

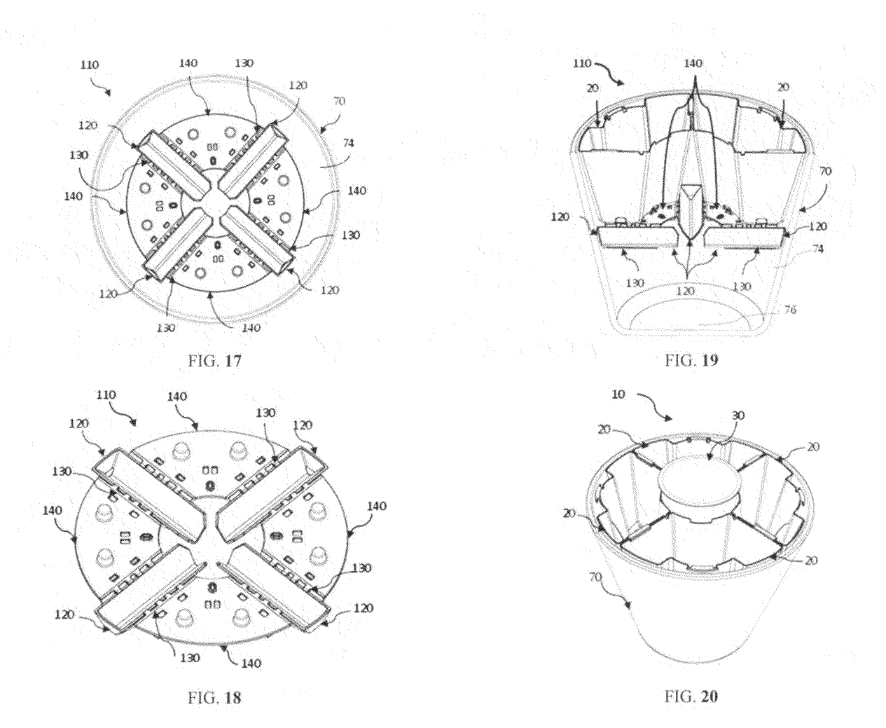

A stabilization portion 130 may hold the platform portion 140 at a fixed position within the planter 70. An exemplary stabilization portion 130 may include an expansion member 120. Suitably, the expansion member 120 may be configured to adjustably couple to the stabilization portion 130 to enable the expansion member 120 to extend to an inside planter surface 74 so as to stabilize the planter platform 110, FIG. 17-18, 29, 37-39, 44. Suitable embodiments may include an expansion member 120 extending to the inside wall surface 74 or inside bottom surface 76.

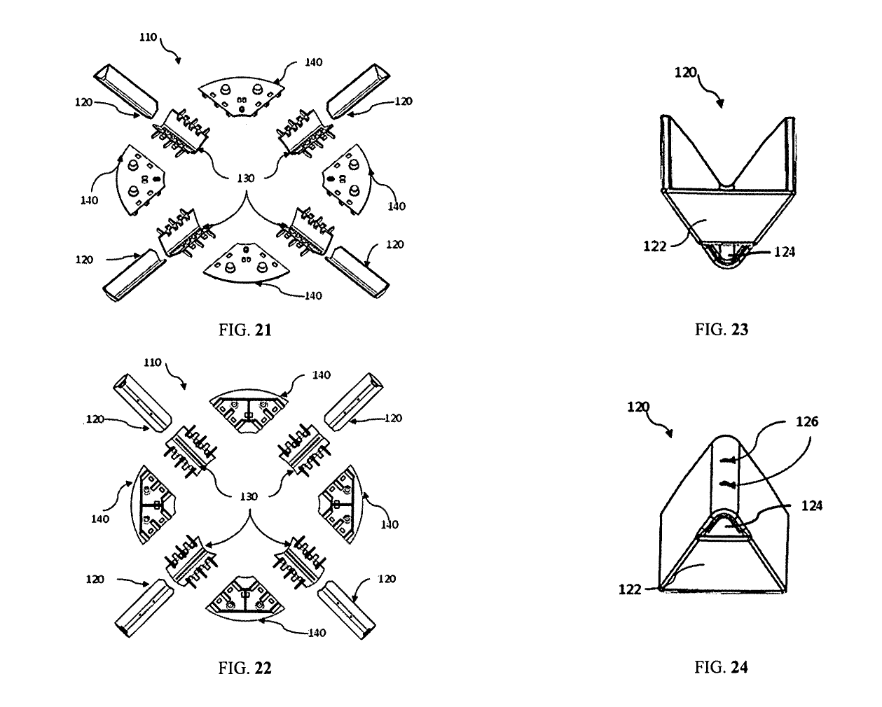

The stabilization portion 130 may suitably be integrally formed with the platform portion 140. However, according to other suitable embodiments, the stabilization portion 130 and platform portion 140 may be modular pieces and connected to one another to form a planter platform 110, FIG. 21-28, 37-39, 41-43. Preferably, the stabilization portion 130 and platform portion 140 may be removably coupled or connected. Suitable embodiments may include a plurality of connectable stabilization portions 130 and platform portions 140. In another suitable embodiment, a stabilization portion 130 and a platform portion 140, or a plurality of stabilization portions 130 and a plurality of platform portions 140 may be integrally formed to form a partial planter platform 110 and may be connected to one another to form a fully assembled planter platform 110.

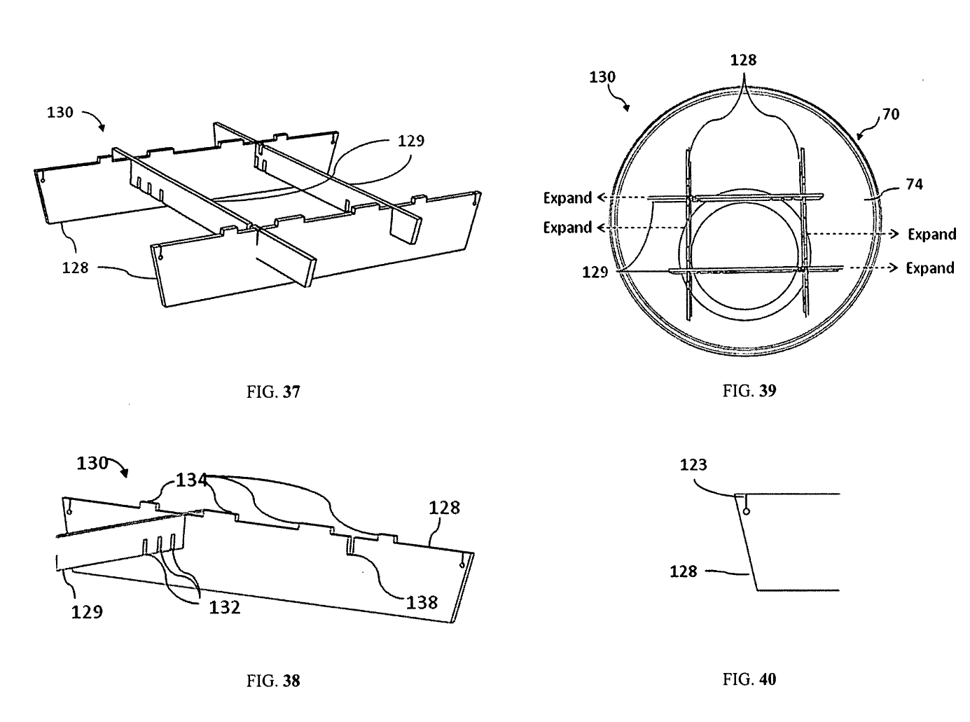

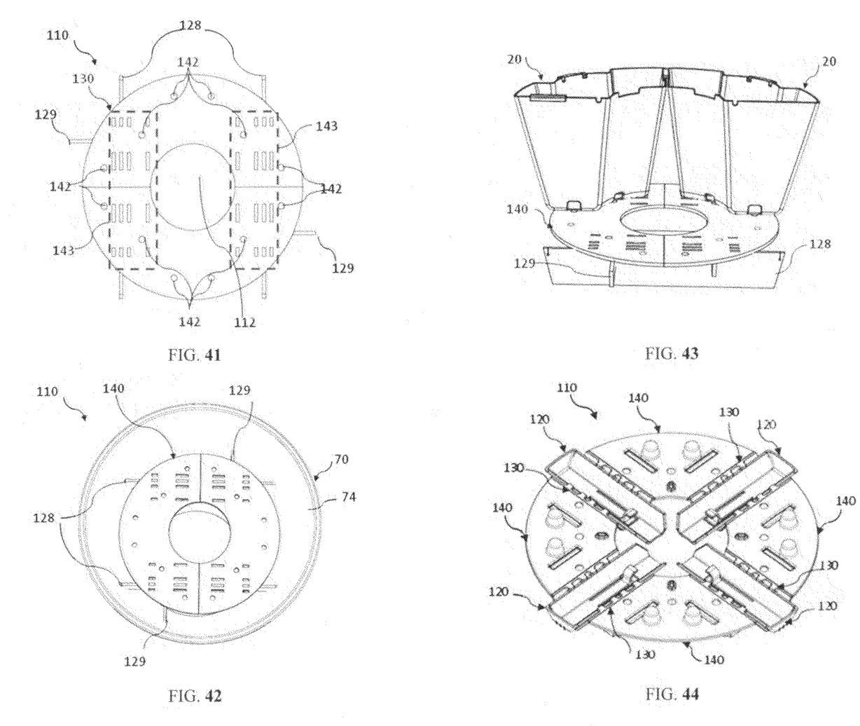

The stabilization portion 130 may be implemented solely as components of an extension member. A suitable embodiment is the expansion member 120 in FIG. 37-39 wherein the stabilizer arm 128 incorporates the expansion member grips 132 and and support brace 129 incorporates the expansion member regulator 138 and stabilization tongue 134.

Generally conforms to the inside shape of a planter 70r: An exemplary planter platform 110 may generally conform to the inside shape of a planter 70, whereby the inside shape and perimeter around the inside planter wall 74 are substantially similar to the outside shape and perimeter around an assembled planter platform 110. For example, the perimeter of a planter platform 110 may be defined with radius for round or oval planters 70, as the width and length (2(w+1)) for a square or rectangular planter 70, or any other such mathematical references depending on the shape of the planter 70. An example of a planter platform 110 for a circular planter 70 is given in FIG. 17-20, 42, 44.

Support for a plurality of container inserts: An exemplary planter platform 110 may support smaller containers or container inserts 10 that may substantially fill the top/open surface area of a planter 70. The containers or container inserts 10 may minimize or altogether eliminate any visibly unused space in the surface of the planter 70 as shown in FIG. 20. According to a suitable embodiment, containers or container inserts 10 may hold a plant(s) and soil (or support foam and artificial plants/flowers). The containers or container inserts 10 may hold plants such as flowers, vegetables, herbs, indoor plants, shrubs, small trees, or any other type of plant. Optionally, the containers or container inserts 10 may hold artificial plants, fresh cut flowers, ornamental gardening objects or any other object that may conceivably be placed in a planter 70.

Container Riser: Any of the containers or container inserts 10 may be elevated on the planter platform 110 for better visibility using a container riser 150. A suitable embodiment of a container riser 150 may elevate an independent vessel 30, FIG. 20. Suitably, the container riser 150 may be modular and/or adjustable with many height settings, or limited to a few fixed heights. According to another suitable embodiment, the container riser 150 may be removably coupled to the planter platform 110 to increase the stability of the container riser 150. The container riser 150 may be inverted to provide an alternate height setting.

A suitable embodiment of a container riser is illustrated in FIG. 31, 32. The container riser 150 may be a single structure or one that is modular which can be assembled or disassembled as needed. A suitable configuration for a modular container riser 150 may have a first side riser portion 152 and a second side riser portion 154, connected with a first side riser connection portion 156 and a second side riser connector portion 158 that may be removably coupled, FIG. 32.

Container Stabilization system 170: The planter platform 110 may implement a container stabilization system 170 to more securely hold objects and help prevent them from shifting. Suitable embodiments of a container stabilization system include a container hook 146 and a riser stabilizer 148.

The planter platform 110 may provide stabilizers specifically to help prevent a container or container insert 20 from shifting after set in place on the platform. Theses stabilizers may also aid in guiding the placement of the container or container insert 20 into a desired fixed position such as optimal placement for better drainage, as can be seen in FIG. 19 where container drainage holes 60 from the container empty directly into the stabilization portion 130. The stabilizer may be very adaptable and generically support most any container or it may be rigid and require a custom designed container insert 20. A suitable embodiment of a stabilizer for the container insert 20 on a planter platform 110 is the container hook 146, FIG. 27, 49. The container hook 146 may also be described as a rod, dowel or shaft. The container hook 146 may work in conjunction with a receiving stabilizer on the container or container insert 10. A suitable example of a receiving stabilizer for the container hook 146 is the container stabilizer receptacle 27, FIG. 34, which is simply the reverse image of the container hook 146 and provides a secure fit when the two are paired.

The planter platform 110 may also provide a stabilizer specifically for a container riser 150 to keep it in place and to help prevent it from shifting. A suitable embodiment of such a stabilizer for a container riser 150 is the riser stabilizer 148 which grips the end-points or feet, of a container riser 150 and secures it in place on the planter platform 110, as shown in FIG. 27, 31, 49.

Expansion mechanism: The planter platform 110 may be adapted to fit in incrementally larger planters 70 of similar shape and dimension with the use of an expansion mechanism. The expansion mechanism may also help to compensate for discrepancies or differences in planter 70 tapers. Without an expansion mechanism, the container platform may be left in a fixed dimension and limit or narrow its range of suitable planters 70.

A suitable embodiment of an expansion mechanism is the expansion member 120, which is an architectural element that moves independently from but is tightly held by the stabilization portion 112, FIG. 17-19, 21-24, 29, 36, 44-46. The expansion member 120 may be expanded or contracted as required for the planter platform 110 to reside at a desired/fixed position and depth within the planter 70. The desired/fixed position is generally defined by the user as a depth sufficient to adequately hold the container and display its contents, while minimizing its outward exposure from the planter 70.

Another suitable embodiment of an expansion member 120 is shown in FIG. 37-39 which may also serve a the stabilization portion 130. The expansion member 120 continues to move independently from the platform portion 140 and expand or contract for the planter platform 110 to reside at a fixed position within the planter 70.

Modular or Singular: The planter platform 110, minus the expansion mechanism, may be molded together as a singular design or subdivided into a more modular approach by subdividing the planter platform 110 into multiple smaller segments which can be assembled for use or disassembled for easy storage. Subdividing the planter platform 110 may also minimize costs associated with packaging, storage, shipping and shelf space.

A suitable configuration of components for a modular planter platform 110 is the platform portion 140 and the stabilization portion 130. FIG. 21-22, 41-44 show exemplary configurations of a modular planter platform 110 for a circular planter 70 with a platform portion 140 and a stabilization portion 130. An adaptation of the shape may be required of most planter platforms 110 so that the assembled planter platform 110 may conform to the general inside shape of other planter 70 shapes such as square or rectangle. The stabilization portion 130 may be optional in the design.

The platform portion 140 may be of any shape, but suitably will follow the inside shape of the target planter 70, minus any stabilization portions 130, and divided into segments/wedges.

For ease of reference purposes only, a singular planter platform 110 will be described in this document in terms of the stabilization portions 130 and platform portion 140 as common components.

Interlocking modular components: A modular planter platform 110 may be held in place with an interlocking mechanism to maintain the desired shape once assembled.

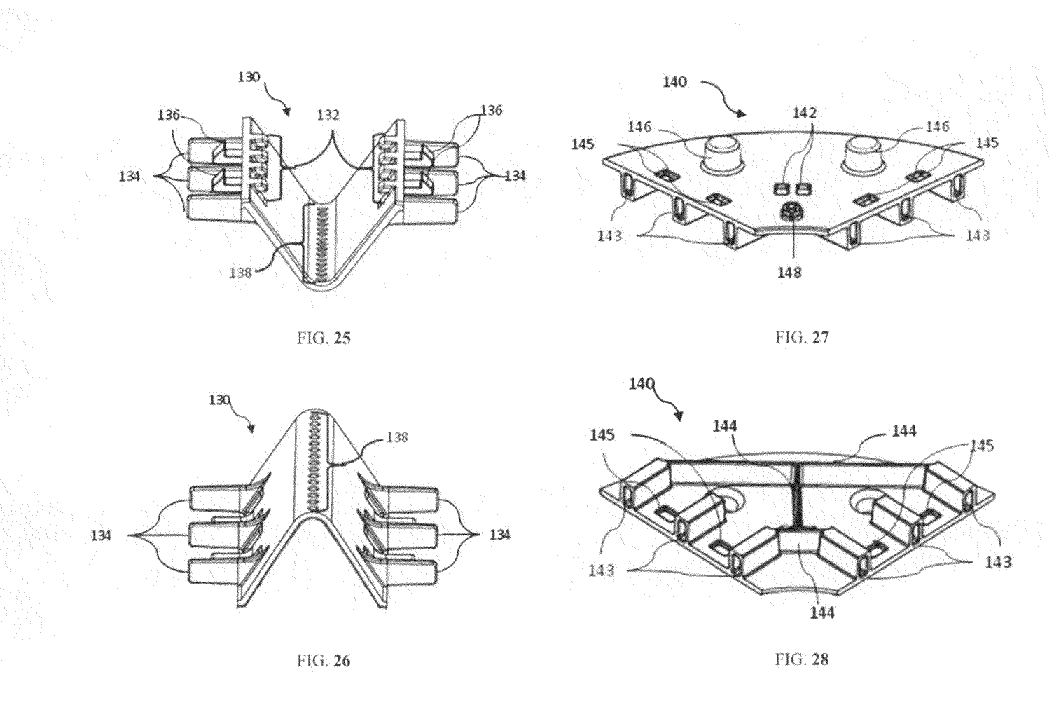

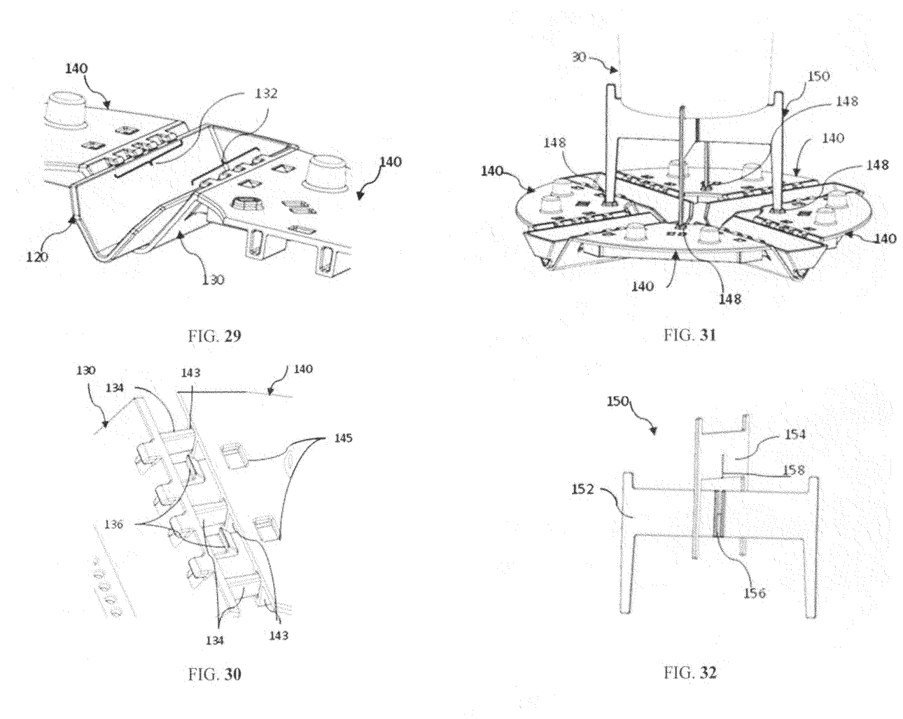

A suitable configuration of an interlocking mechanism is the stabilization tongue 134 and platform groove 143, whereby the stabilization tongue 134 on the stabilization portion 130 is removably coupled with the platform groove 143 on the platform portion 140, thereby creating a forcibly fit connection, FIG. 25-28, 30, 38, 41-42, 47-50.

Another suitable configuration of an interlocking mechanism is the stabilization hook 136 and the platform eye 145, where the stabilization hook 136 on the stabilization portion 130 is removably coupled with the platform eye 145 on the platform portion 140, which may lock the two components together until the stabilization hook 136 is depressed, thereby releasing it from the platform eye 145, FIG. 25-28, 30, 47-50

Independently removable and swappable: The planter platform 110 may be independently removable from the planter 70, meaning it is independent from, rather than fixed to, the planter 70. The planter platform 110 may easily be added to or removed from the planter 70 when the containers are absent.

The planter platform 110 may be swappable with planters 70 of similar shape and dimension.

Utilizing the space below a planter platform 110: The planter platform 110 may be adapted to utilize the space below the planter platform 110. Suitably, the space below the planter platform 110 may be used for root expansion, a water reservoir for a self watering system 180, a lighting system, or storage.

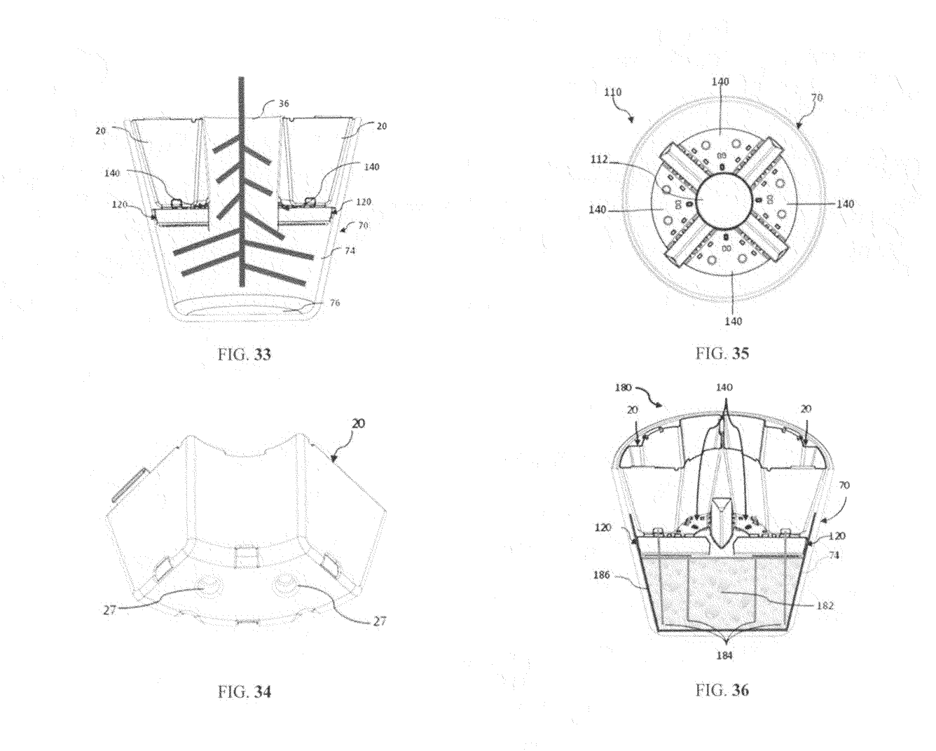

A suitable embodiment may permit loose soil beneath the planter platform 110 to enable a plant to utilize the unused portion of the planter 70 below the planter platform 110 to expand its root system. A suitable embodiment may include a platform cavity 112 allowing a plant to be added directly to soil beneath the planter platform 110. Most suitably, an opening in the center of the planter platform 110 may be utilized. Another suitable embodiment may include a container with the bottom cut out. A suitable embodiment of a bottom-less container is the open-bottom container 36 in FIG. 33, where a plant may utilize the soil typically provided by a container but then expand its roots to the soil in the planter 70 below the planter platform 110.

In both configurations above, the planter platform 110 may provide an opening to the soil beneath its surface. A suitable example is the platform cavity 112, where a portion of the planter platform 110 is removed to permit a plant's roots to permeate the soil below, FIG. 35, 41.

According to another suitable embodiment, the space below the planter platform 110 is used to house a self watering system 180, which may include a water container and one or more capillary wicks 184 to carry the water from the water container to the soil in each container, independent vessel 30 or container insert 20, suitably thru the container drainage holes 60. A suitable embodiment of a water container is the water reservoir 182. One end of the capillary wick 184 is suitably inserted into a container, independent vessel 30 or container insert 20, whereas the other end of the capillary wick is placed in the water reservoir 182. The planter platform 110 may be optimized to allow capillary wicks 184 to hang freely through a platform water outlet 142 or other suitable opening on the planter platform 110 and down into the water container 182. The water container 182 may be the planter itself or some other kind of insert such as a plastic liner 186. The water container 182 may be securely held in place in close proximity to the inside planter wall 72 by the planter platform 110, more suitably by the expansion member 120, FIG. 36, 44, 49-50.

According to another suitable embodiment, the space below the planter platform 110 is used to house a lighting system.

According to another suitable embodiment, the space below the planter platform 110 may be used as an anchor for a post or pole. The pole or post may be made of wood, metal, plastic, fiberglass or of some other material. The anchor may be a stand designed to hold the pole or post, or it may be made by pouring a hardening substance into the bottom of the platform below the planter platform 110, such as cement. The purpose of the anchor may be to hold a tent pole, a flag pole or a sign. Multiple planters 70 used in succession may be connected to one another to form a barrier, by having a cord or chain connecting each pole. Container inserts may then be added to conceal the anchor and beautify the over-all appearance of the planter 70.

Drainage systems: The planter platform 110 may implement drainage system 160 to minimize pooling on and divert water away from the platform. A suitable configuration of a drainage system 160 is the expansion member 120, which acts as a furrow and channels water away from the planter platform 110. Another suitable configuration of a drainage system 160 is the platform water outlet 142, which drains water directly from the planter platform 110 surface. A suitable configuration may have a plurality of expansion members 120 and a plurality of platform water outlets 142, in FIG. 17-19, 21, 23-24, 27-28, 41, 45-46, 49-50.

Weight-bearing mechanisms: It will be understood that by placing containers with soil on the planter platform 110, the planter platform 110 becomes more directly wedged in place at a select container periphery. The planter platform 110 may implement weight-bearing mechanisms to prevent sagging or to reinforce the strength of the planter platform 110 to support the weight of the plurality of containers, independent vessel 30 and/or container inserts 10.

A suitable configuration of a weight-bearing mechanism is a support rib which may be integrally formed and added to the planter platform 110 to improve its load bearing potential. Support ribs may substantially be equally-spaced from one another. A suitable embodiment of a support rib is the platform rib 144 which is radially aligned from a center portion on the platform portion 140, more suitably the side facing the inside bottom surface 76, FIG. 28, 46. It is noted that given a differently shaped planter platform 110, the arrangement of support ribs 144 may vary. For a square planter platform 110, platform ribs 144 may be aligned in a grid or a joist like pattern. Platform ribs 144 provide the planter platform 110 with additional load bearing structure to withstand the various forces from the containers, independent vessel 30 and/or container inserts 10.

Another suitable configuration of a weight-bearing mechanism is a v-shape of the stabilization portion 130 of the planter platform 110.

Stackable: The planter platform 110 may be stackable when molded as a singular component or when a modular planter platform 110 is fully assembled. When a modular planter platform 110 is disassembled, components of similar kind may be stackable. The expansion mechanism 120 may also be independently stackable.

6. Suitable Platform Expansion Mechanism

The planter platform 110 may be adapted to fit in larger planters 70 of similar shape and dimension with the use of an expansion mechanism. A suitable example of an expansion mechanism is the expansion member 120.

Expansion locking mechanisms: The expansion mechanism may be held in place by one or more expansion locking mechanisms.

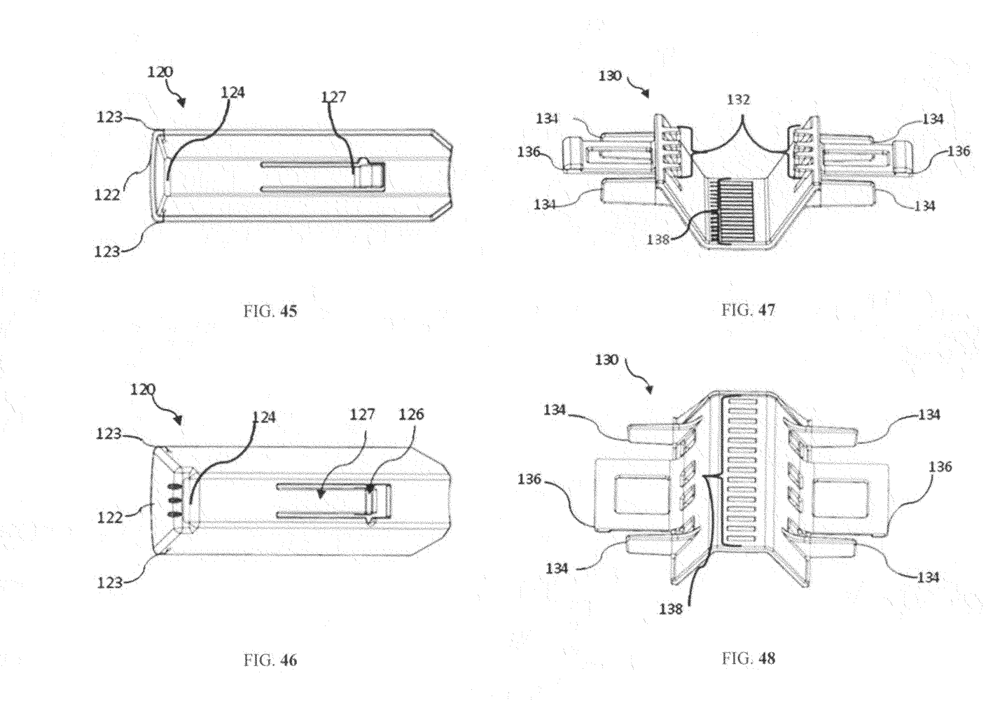

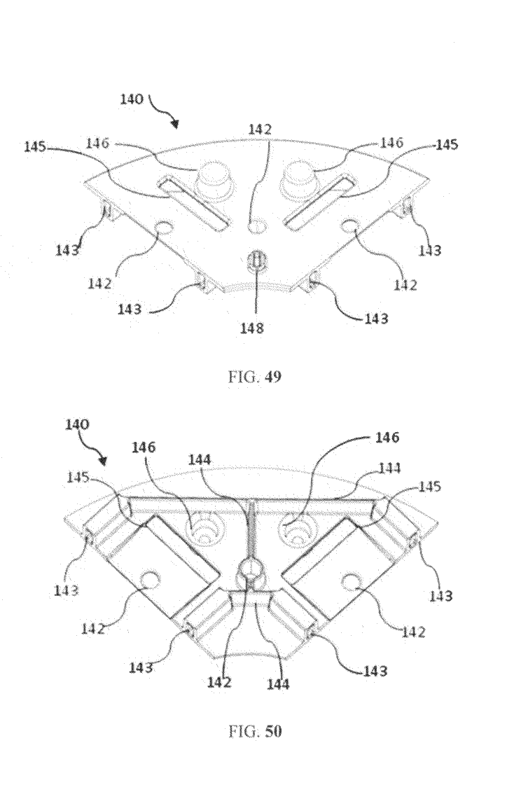

A horizontal expansion locking mechanism may secure the expansion mechanism horizontally to the planter platform 110 in a desired position in relation to the planter 70, thereby preventing it from slipping by either expanding or contracting. A suitable example of a horizontal expansion locking mechanism is to anchor a single or a plurality of adjustable expansion member dowels 126 on the bottom of the expansion member 120 FIG. 24, 46, with a single or a plurality of expansion member regulators 138 on the stabilization portion 130, FIG. 25-26, 47-48. Another suitable location for the expansion member dowel may be on an expansion member lever 127, FIG. 45-46. The expansion member dowel 126 may also be described as the male component, whereas the expansion member regulator 138 on the stabilization portion 130 may be considered the female component The insertion of the expansion member dowel 126 in the expansion member regulator 138 may be further held in place by the vertical expansion locking mechanism as explained below.

A vertical expansion locking mechanism may secure the expansion mechanism vertically to the planter platform 110, thereby preventing it from lifting or dropping from the added weight of the containers or container inserts 10. A suitable example of a vertical expansion locking mechanism is the plurality of expansion member grips 132 on the stabilization portion 130, which securely hold the expansion member 120 in place, FIG. 25, 29, 47. The expansion member grips 132 may help prevent the expansion mechanism from lifting, while the stabilization portion 130 may prevent the expansion mechanism from dropping. An exemplary configuration would include a plurality of expansion member grips 132 along both sides of the stabilization portion 130. The expansion member grips 132 may create a tight fit with the expansion mechanism, thereby helping to anchor or secure the horizontal expansion locking mechanism in place.

There may be multiple types of expansion members 120 in a completed planter platform 110. Another suitable embodiment of an expansion mechanism is the support brace 128 and stabilizer arm 129 in FIG. 37-39. The support brace 128 and stabilizer arm 129 may substantially comprise the stabilization portion 130 for a planter platform 110. Each support brace 128 may move outwards radially to adjust to larger planters 70 and may provide the principal weight-bearing capabilities for the stabilization portion 130, FIG. 39. The function of the stabilizer arm 129 may be to keep the support braces 128 at a set equal-distance apart from one another, and may contribute towards the weigh-bearing characteristics of the planter platform 110. Each stabilizer arm 129 may move front-to-back in opposing directions so one end of each stabilizer arm 129 may maintain contact with the inside wall surface 74. The support brace 128 may use an expansion regulator 138 to lock with an expansion member grip 132 on the stabilizer arm 129. Either or both of the support brace 128 and stabilizer arm 129 may include locking mechanisms to secure the platform portion and together make up a planter platform 110.

Weight distribution mechanism: The expansion mechanism may include a weight distribution mechanism to disperse the force of the planter platform 110, as it makes contact with the inside planter surface 72. A suitable example of a weight distribution mechanism is a foot pad 122 attached to the expansion member 120 at the end closest to the inside planter surface 72. The foot pad 122 may increase the surface area of the expansion member 120 on the inside planter surface 72. The foot pad 122 may take many shapes, though an exemplary configuration would mimic the expected tapered surface of the inside wall surface 74, thereby increasing the contact surface for greater weight distribution, FIG. 23-24, 45-46. It can also be said of the general shape of the foot pad 122, that its surface area for making contact with the inside planter surface 72 may be greater than what the expansion mechanism alone would have provided.

The foot pad 122 may be permanently attached to the expansion member 120 or it may be designed as an add-on that is removably coupled with the expansion member 120. The surface of the foot pad 122 may be designed to maximize friction for increased stability when making contact with the inside planter wall 72. Suitable methods for improving the friction capabilities of the foot pad 122 may include a textured surface or application of a friction-causing substance to the foot pad 122 such as a substance that includes rubber, an abrasive substance or any other suitable friction-causing substances.

The expansion member 120 may be designed to secure a water reservoir 182 for a self-watering system 180 with a water liner hook 123. A suitable example is for one or more plastic liners 186 to be held between the removably coupled foot pad 122 and the expansion member 120, to secure the plastic liner close to the inside wall surface 74, FIG. 36. Another suitable embodiment of a mechanism whereby an expansion member 120 may secure a plastic liner 186 to the inside wall surface 74, is the water liner hook 123, FIG. 40, 45-46. A plastic liner 86 may be inserted into the water liner hook 123 and then pinched tight once the planter platform 110 is inserted into the planter 70 and downward force is applied by the weight of the contatiners or container inserts 10.

Expansion Drainage mechanism: The expansion mechanism may include a drainage system 160 to facilitate drainage by channeling water away from the planter platform 110. A suitable embodiment of a drainage system 160 is the v-shaped contour of the expansion member 120 which may channel water away from the planter platform 140 and container inserts 10, down to the planter 70. The expansion member 120 opens towards the middle of the planter 70 and also includes an ankle drain 124 at the opposite end which drains water near the inside wall surface 74, FIG. 23-24, 45-46.

7. Planter Platform Materials

The planter platform 110, including the platform portion 140, the stabilization portion 130, the expansion member 120, the foot pad 122 as well as the container riser 150 may be made with a variety of materials and methods. In an exemplary embodiment, materials may be of molded plastic material or polymer. More suitably, these components may be made from injection molding using ABS like material or Thermo-forming using a variety of composite materials.

1. A planter platform comprising:
a. at least one platform portion,
b. at least one stabilization portion, and
c. at least one expansion member wherein
d. the at least one expansion member is adjustably coupled to the stabilization portion enabling the expansion member to adjustably expand away from the platform portion and contact an inside planter surface.

2. The planter platform of claim 1 further comprising an adjustable locking system.

3. The planter platform of claim 2 wherein the adjustable locking system includes the stabilization portion including a first locking means and the at least one expansion member including a second locking means, wherein the first locking means is configured to adjustably connect to the second locking means.

4. The planter platform of claim 1 wherein the first locking means includes expansion member grips and the second locking means includes a gripping surface.

5. The planter platform of claim 1 wherein the platform portion includes a center point and the expansion member is configured to adjustably move away from the center point and contact an inside wall surface of a planter

6. The planter platform of claim 1 wherein the platform portion includes a bottom portion and the expansion member is configured to adjustably move away from the inside bottom surface and contact an inside wall surface of the planter located below the bottom portion of the platform portion.

7. The planter platform of claim 1 further comprising a container stabilization system configured to removably couple to a container insert.

8. The planter platform of claim 7 wherein the platform portion includes a first connector and the container insert includes a second connector responsive to the first connector.

9. The planter platform of claim 1 wherein the planter platform includes a center point and is configured to form a cavity around the center point.

10. The planter platform of claim 1 wherein the plurality of platform members include plastic.

11. The planter platform of claim 1 further comprising a drainage system.

12. The planter platform of claim 1 further comprising a lighting system.

13. The planter platform of claim 1 further comprising a container riser system.

14. The planter platform of claim 13 wherein the platform portion includes a first connector and the container riser system includes a second connector responsive to the first connector.

15. The planter platform of claim 13 wherein the riser system includes a first side portion and a second side portion adapted to be removably coupled to the first side portion.

16. A modular planter platform comprising:
A. a plurality of platform members including a first means for connecting and a second means for connecting,
B. wherein the first means for connecting is configured to connect to the second means for connecting enabling one of the plurality of platform members to be connected to another of the plurality of platform members.

17. The planter platform of claim 16 wherein the first means for connecting includes a platform eye system and the second means for connecting includes a stabilization hook system.

18. The planter platform of claim 16 wherein the first means for connecting includes a platform groove system and the second means for connecting includes a stabilization tongue system.

19. The planter platform of claim 16 wherein the plurality of planter members comprises a plurality of support members and a plurality of stabilization members.

20. The planter platform of claim 19 wherein the support member is integrally formed with the stabilization member.

21. The planter platform of claim 19 wherein
a. the plurality of support members includes at least a first support member and a second support member each including a first side portion including the first means for connecting and a second side portion including the first means for connecting, and
b. the plurality of stabilization portions includes at least a first stabilization member and a second stabilization member each having a first side portion including the second means for connecting and a second side portion including the second means for connecting; wherein
c. the first means for connecting of the second side portion of the first support member is configured to connect to the second means for connecting of the first side portion of the first stabilization member,
d. the first means for connecting of the first side portion of the second support member is configured to connect to the second means for connecting of the second side portion of the first stabilization member, and
e. the first means for connecting of the second side portion of the second support member is configured to connect to the second means for connecting of the first side portion of the second stabilization member.

22. The planter platform of claim 19 further comprising an expansion member adjustably coupled to the the stabilization portion enabling the expansion member to extend away from the stabalization portion to contact an inside surface of the planter.

23. A planter platform comprising:
a. a plurality of platform members including a top surface, a first portion, and a second portion, wherein
i. the first portion of the platform members is configured to couple to the second portion of another of the plurality of platform members; and
ii. at least one of the platform members includes a stabalization portion;
b. at least one expansion member, wherein
i. the expansion member is adjustably coupled to the stabalization portion enabling the expansion member to project away from the stabalization portion to contact an inside surface of the planter located below the top surface of the platform member.
